(19) United States
(12) Patent Application Publication
(10) Pub. No.: US 2009/0158822 A1
(43) Pub. Date: Jun. 25, 2009

(54) DEVICES, METHODS AND SYSTEMS FOR MEASURING ONE OR MORE CHARACTERISTICS OF A BIOMATERIAL IN A SUSPENSION

(75) Inventors: Zongqi Sun, Albany, NY (US); Mohan Mark Amaratunga, Clifton Park, NY (US); Nicole Lea Wood, Niskayuna, NY (US); Christopher James Sevinsky, Watervliet, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/962,219

(22) Filed: Dec. 21, 2007

Related U.S. Application Data
(63) Continuation-in-part of application No. 11/961,070, filed on Dec. 20, 2007.

(51) Int. Cl. G01N 15/06; G01V 13/00

(52) U.S. Cl. 73/61.75; 73/1.83

(57) ABSTRACT

A system for measuring one or more ultrasound parameters of a suspension comprising particulate biomaterial dispersed in a liquid carrier comprising, a bioprocessor for processing the particulate biomaterial; an immersible device comprising an ultrasound probes and a reflector; a housing, that fixes the probe and the reflector at positions with a space in between the probe surface and the reflective surface, comprising an opening into the housing that is of a size sufficient to allow the suspension to flow into the space between the probe surface and the reflective surface; an ultrasound wave generator/receiver device; and a signal processing device.

### CROSS REFERENCE TO RELATED APPLICATIONS

This application is a continuation-in-part of U.S. patent application Ser. No. 11/961,070, entitled “DEVICES, METHODS AND SYSTEMS FOR MEASURING ONE OR MORE CHARACTERISTICS OF A SUSPENSION”, filed Dec. 20, 2007, which is herein incorporated by reference.

### BACKGROUND

The invention relates generally to devices, methods and systems for measuring one or more characteristics of a suspension.

Suspension concentration is one of many important parameters in biological processes such as a microbial cell growth process. The current concentration measurements may be taken off-line and are manual and time consuming. In-line concentration measurements have been carried out using optical refractive indices for many years. However, most of these optical systems are only capable of measuring suspensions with low concentration (usually <10%) and that are relatively transparent. Optical refractive index methods require users to dilute the suspensions if the concentrations are high (usually >10%) before optical measurements can be taken, which introduces additional errors into the measurement process. Methods that are based on refractive index are also unable to penetrate liquids that are opaque or nearly opaque. For high concentration and opaque suspension samples, current optical methods are insufficient. In addition, biofouling is associated with optical devices. For example, microbial growth on the optical devices prevents or otherwise limits their use in bioreactors and fermenters.

Many ultrasonic measurement instruments have been developed over the past two decades for suspension concentration measurements for different industrial applications. Some of them require off-line measurements, taking suspension samples out of the original container.

The limitations of current methods demonstrate that there is a need for a suspension concentration sensor, particularly a sensor that can propagate over a relatively long distance with low attenuation even when the sample is opaque. The ideal sensor should be fast, robust and reliable for determining suspension concentration. An in-line (real time) suspension concentration sensor would also enable automated measurements, which would greatly simplify industrial workflow, reduce human errors and improve large-scale production repeatability and cost effectiveness.

### BRIEF DESCRIPTION

The ultrasonic devices, methods and systems of the invention are more accurate, faster and more efficient than previous methods and may be readily adapted for automation and portability. These devices, methods and systems are useful in various processing industries such as the pharmaceutical, biomedical, chemical, petrochemical, and food processing industries. For example, they are readily adaptable for applications in which liquids or suspensions need to be characterized, measured or analyzed including, but not limited to, chromatography column packing, brewing, fermenting, food manufacturing, refining and bioprocessing.

One or more of the embodiments of the devices, methods and systems comprise an ultrasound device with a two-step reflector system that, in some of the embodiments, is adapted to calibrate either or both velocity and attenuation based on buffer alone and/or on homogeneous suspension measurements. One or more of the embodiments of the methods and systems may also use dual devices and data analysis processors that are adapted to incorporate a dual device system. These devices, methods and systems may be adapted for in-line or off-line use, and may be adapted for a flow-through system and/or a system in which the ultrasound device is built in to the suspension processing system. Any number and variety of parameters may be measured including, but not limited to, concentration, density and rate of settlement.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of an embodiment of the immersible device of the invention.

FIG. 2 is a schematic view of an embodiment of the system of the invention.

FIGS. 3a and 3b are schematic views of an embodiment of an immersible device with at least two reflective surfaces.

FIG. 4 is a graph of an embodiment of a waveform generated from using a two-surface reflector design.

FIG. 5 is a graph illustrating example levels of variability when a stirring bar is used.

FIG. 6 is a graph show a suspension velocity vs. suspension % for one set of QFF samples.

FIGS. 7a and 7b are graphs showing examples of the potential difference in velocity between liquid carriers.

FIG. 8 is a graph showing a corrected velocity vs. suspension % for four different bead materials.

FIG. 9 is a graph showing the effect of temperature variations on velocity measurements.

FIG. 10 shows a 3D regression plot of velocity vs. concentration and temperature.

FIG. 11 is a schematic diagram of an embodiment of a portable device of the invention.

FIG. 12 is a perspective view of an embodiment of a portable device of the invention.

FIG. 13 is a schematic diagram of an embodiment of a flow-through ultrasound measurement system of the invention.

FIG. 14 is a schematic diagram of an embodiment of a built-in ultrasound measurement system of the invention.

FIG. 15 is a graph illustrating the results using an embodiment of the system for measuring ultrasound parameters of a cell culture comprising cells dispersed in a liquid media.

### DETAILED DESCRIPTION

To more clearly and concisely describe and point out the subject matter of the claimed invention, the following definitions are provided for specific terms that are used in the following description.

As used herein, the term “biomaterial” refers to material that is, or is obtained from, a biological source. Biological sources include, for example, materials derived from, but are not limited to, bodily fluids (e.g., blood, blood plasma, serum, or urine), organs, tissues, fractions, cells, cellular, subcellular and nuclear materials that are, or are isolated from, single-cell or multi-cell organisms, fungi, plants, and animals such as, but not limited to, insects and mammals including humans. Biological sources include, as further nonlimiting examples, materials used in monoclonal antibody production, GMP inoculum propagation, insect cell cultivation, gene therapy, perfusion, E. coli propagation, protein expression, protein amplification, plant cell culture, pathogen propagation, cell therapy, bacterial production and adenovirus production.

As used herein, the term “liquid carrier” refers to any liquid, without limitation on the density, viscosity or chemical or biological composition of the liquid, in which particulates are suspended or, otherwise, carried and is not limited to any specific composition or material. The term is used only to distinguish the liquid from the particles or particulate matter for purposes of this description. The terms particles and particulate matter are used interchangeably and are not limiting, and include any particle or matter that can be suspended, at least temporarily, in a liquid.

As used herein, the term “bioprocessor” refers to any device or system, automated or manual, that is used to measure, propagate, culture, separate, characterize or, otherwise, process biological materials.

One or more of the embodiments of the systems for measuring one or more ultrasound parameters of a suspension comprising particles dispersed in a liquid carrier generally comprises: one or more immersible devices, comprising, one or more ultrasonic probes, adapted to transmit and receive ultrasound waves, and having a surface; one or more reflectors having at least one reflective surface positioned to reflect the ultrasound waves onto the probe surface; a housing, that fixes the probe and the reflector at positions with a space in between the probe surface and the reflective surface, comprising an opening into the housing that is of a size sufficient to allow the suspension to flow into the space between the probe surface and the reflective surface; an ultrasound wave generator/receiver device, in communication with the immersible device to transmit and receive the ultrasound waves to and from the immersible device; and a signal processing device, in communication with the ultrasound wave generator/receiver to receive and process the ultrasound waves.

To self-calibrate the distance between the reflector and the probe, one or more of the embodiments comprise a reflector that has at least two reflective surfaces positioned at staggered distances from the probe surface. To calibrate the liquid carrier and/or the suspension, the system may also comprise two or more immersible devices, at least one of which is adapted to calibrate the liquid carrier by further comprising a filter adapted to prevent the particles from flowing into the space while allowing the liquid carrier to flow into the space of the calibrating immersible device.

One or more of the systems uses a method for measuring one or more ultrasound parameters of a suspension comprising a plurality of particles dispersed in a liquid carrier, comprising the steps of: a) introducing into the suspension, one or more immersible devices: b) initiating transmission of the ultrasound waves from the probe through the suspension flowing into the space between the probe surface and the reflective surface; and c) processing the ultrasound waves reflected onto the probe surface, to determine one or more of the ultrasound parameters of the suspension, such as but not limited to, ultrasound velocity. One or more of the embodiments of the methods preferably comprises determining a substantially contemporaneous temperature of the suspension, and wherein the ultrasound velocity is determined in part by the temperature of the suspension, wherein the processing step further comprises determining a concentration measurement of the particles in the suspension based at least in part on the ultrasound velocity.

One example embodiment of the system comprises two ultrasonic probes, two reflector blocks, a housing to fix the probe and reflector in relative positions, in communication with a signal generator/receiver and one or more processing devices. This system may be adapted as a component of a variety of processing systems such as, but not limited to, stationary and wave bioreactors for cultivating various biomaterials.

One of the probe/reflector pairs (otherwise referred to herein as an immersible device) is immersed in the suspension directly, and the other probe/reflector pair comprises a filter, which allows only the liquid carrier, such as a culture medium, to flow between the probe surface and the reflective surface and blocks particulate matter from entering when immersed in the suspension. By measuring ultrasonic velocities, attenuations, and reflection/transmission coefficients in suspension, the concentration of the particles in the suspension may be determined with an accuracy that is +/−1%. Culture medium variations may be removed from the data analysis algorithms when using a dual immersible device system. The immersible device may also comprise two or more staggered reflective surfaces, which reduce distance variation between the probe and the reflector, to improve the accuracy of the ultrasound measurements.

One non-limiting example system into which one or more of the embodiments of the invention may be incorporated is a wave bioreactor. Wave bioreactors, in general, comprise a disposable plastic bag partially filled with a cultivation medium and then the remaining headspace is filled with a predetermined gas mixture. The bag is then placed in a wave device that generates a wave-like motion in the liquid in the bag to mix the components of the bag without introducing undesirable bubbles or air pockets in the culture medium or liquid carrier which might comprise several components including but not limited to media, buffer and cell nutrients such as glucose stock solution.

The waves in the device may be generated using a variety of means including, but not limited to, single rockers that rocker to and from around a single axis or multi-axis tilt rockers that tilt around multiples axes. The wave activity depends on the volume of liquid, the angle of the rotation or tilt and the speed of the rocking per minute. The volume of liquid in these bioreactors ranges from 0.1 to 500 liters. (Wave Bioreactor, General Electric)

These devices are equipped with certain nonintrusive probes for measuring characteristics of the medium such as pH and temperature. The devices are also equipped with ports for introducing sterilized materials into the bag and for removing samples. The immersible devices of one or more embodiments of the invention are readily adapted for use in such processes. For example, the immersible ultrasound device may be introduced into the suspension via an existing port or through a port specifically dedicated to the immersible ultrasound device. Use of the devices, methods and systems of one or more of the embodiments in such bioreactors will enable more efficient processing and perfusion or cell harvesting. In addition to measuring the cell density in the culture medium, the ultrasound device may be used to measure the accumulation of lactate and other toxic products of cell propagation, to further improve the efficiency of the bioreactor processes.

Data analysis algorithms used in one or more embodiments of the systems and methods may be adapted to calculate calibrated ultrasound parameters based on media and/or buffer only and homogeneous suspension measurements. This process for calibrating the parameters greatly reduces the influence that liquid carrier variations have on measurement accuracy. The dual probe design helps to acquire both the culture medium only and suspension ultrasound parameters in one measurement without requiring time consuming settling steps. The data analysis steps may also incorporate data interpolation and correlation to accurately calculate TOF.

Although ultrasound parameters related to suspension concentration generally comprise velocity, attenuation, reflection coefficient and resonant frequency, the latter is not conducive to an in-line measuring system. Of these parameters, velocity is quite sensitive to suspension concentration change (<1%) and is therefore used in one or more of the example embodiments.

Velocity may be divided into phase velocity and group velocity. Phase velocity is the speed of phase change along the wave-propagating path while group velocity is the wave profile moving speed, also called energy speed. If a propagation media is non-dispersive, then phase velocity and group velocity are the same. If the cell propagation media is dispersive, then phase velocity and group velocity are different at different frequencies. Media dispersion is related to suspension bead size distribution. Most suspension concentration measurements are taken at a single frequency (for example, 1 Mhz) and then the group velocities are measured. For descriptive purposes only and without any intended limitation on the scope of the invention, velocity, when used to describe the example embodiments, refers to group velocity.

With a known wave propagation distance, velocities may be calculated based on time difference measurements. There are three widely used time measurement methods: zero crossing, peak amplitude, and cross correlation. Zero crossing locates the time when the wave first crosses zero, either from positive to negative or vice versa. Zero crossing may be efficiently implemented by waveform interpolation and root finding algorithms. Two zero crossing points will provide the time difference from which velocity may be calculated. Peak amplitude methods measure at least two peaks relative to time and calculate the time difference, from which velocity may be measured. Cross correlation methods shift one of at least two waveforms and then compare the similarities between the two waveforms. When the correlation reaches maximum, that point is the time difference between the two waveforms. Zero crossing is used in one or more of the embodiments in part because of its high accuracy and robustness in the presence of waveform distortions.

Acoustic field radiated from an ultrasound probe may be divided into near field and far field. In the near field, wave amplitude changes dramatically while phase is relatively accurate (<0.005% error). In the far field, amplitude changes gradually with monotonic decay and phase error increases because of wave diffraction. The optimal location for time or velocity measurements is in the near field and the optimal location for attenuation measurements is in the far field.

Attenuation may be measured based on the rate of waveform decay, which is usually measured in dB/m or Neper/m (1 Np/m=8.686 dB/m). Different concentrated slurries have different wave attenuations. The measured attenuation represents the overall attenuation, which includes the attenuation associated with the probe (and a buffer rod if it is attached to the probe), the probe and suspension interface, the suspension, the far field diffraction and the plate reflection, if a reflector is used. To optimize the methods and systems that comprise ultrasound attenuation measurements, multiple reflections are preferably recorded rather than just one reflection. To do so, distance between the probe surface and reflector should be tightly controlled.

Reflection coefficient is the ratio of amplitudes of the incoming wave and the reflected wave at the interface between two materials with different acoustic impedances. Acoustic impedance is defined as the multiplication of density and ultrasound velocity in the material where wave propagates through. When suspension concentration changes, both suspension density and ultrasound velocity changes accordingly.

Resonant frequency methods measure vibration frequency change due to liquid mass change with a known volume in a vibrating tube. Then density may be converted into a concentration at a known temperature. Because it is an offline measurement technique, it is generally not suitable for in-line suspension concentration measurement. Velocity is used in one or more of the embodiments because of its high sensitivity and accuracy.

Velocity measurements may use pulsed waves or continuous waves. Pulsed wave based method may use a pulse-echo method wherein a single ultrasonic transducer acts as a transmitter as well as a receiver; and/or a through-transmission method wherein two ultrasonic transducers are used in which one is the transmitter and the other is the receiver. Continuous wave based methods may use interference or generation of stationary waves due to multiple reflections from a sample, where the sample is place between two transducers or is placed between transducer and a reflector. The pulse-echo method is combined with zero crossing in one or more of the embodiments to achieve the high velocity accuracy.

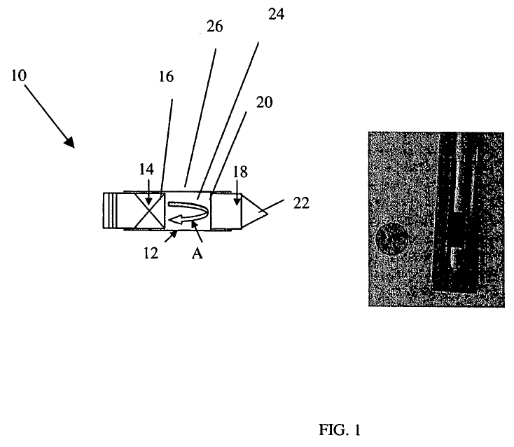

One embodiment of the immersible device of the invention is generally shown and described in FIG. 1 as device 10. Device 10 generally comprises housing 12 with space 24, probe 14 with a probe surface 16, and reflector 18 with a reflective surface 20 and cone 22. Housing 12 may comprise one or more openings 26 into or through the housing to allow the suspension, such as a cell culture suspension, to flow into space 24 between probe surface 16 and reflective surface 20, to enable ultrasound waves being emitted through probe 14 to pass through the suspension in space 24 and reflect off of reflective surface 20 and back to probe surface 16. This wave path is generally shown in FIG. 1 as wave propagation path A. The design and configuration of the immersible device may be modified, as needed by one skilled in the art, to suit a particular use, while still providing the necessary elements of the immersible device.

Reflector 18 has a polished flat surface on one end and a cone 22 on the other end. The flat surface is used to reflect ultrasound waves and the cone shape helps to reduce reflections from the other end. Both the probe and reflector are fixed in position by housing 12. The device may be immersed directly into a suspension. Ultrasound waves are radiated from the probe surface, propagate through the suspension, and are reflected back to the probe by the reflector surface.

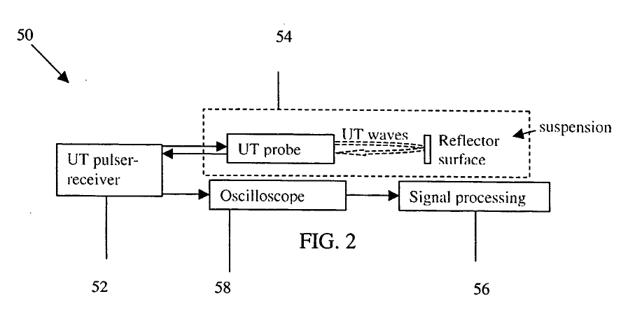

An embodiment of the system of the invention is generally shown and referred to in FIG. 2 as system 50. System 50 generally comprises an ultrasound wave generator/receiver device 52 (e.g. Panametric Pulser/Receiver 5072PR), in communication with the immersible device 54 to transmit and receive the ultrasound waves to and from the immersible device; and a signal processing device 56, in communication with the ultrasound wave generator to receive and process the ultrasound waves from the ultrasound wave generator/receiver device. System 50 may also comprise oscilloscope 58 to display the waveform signals.

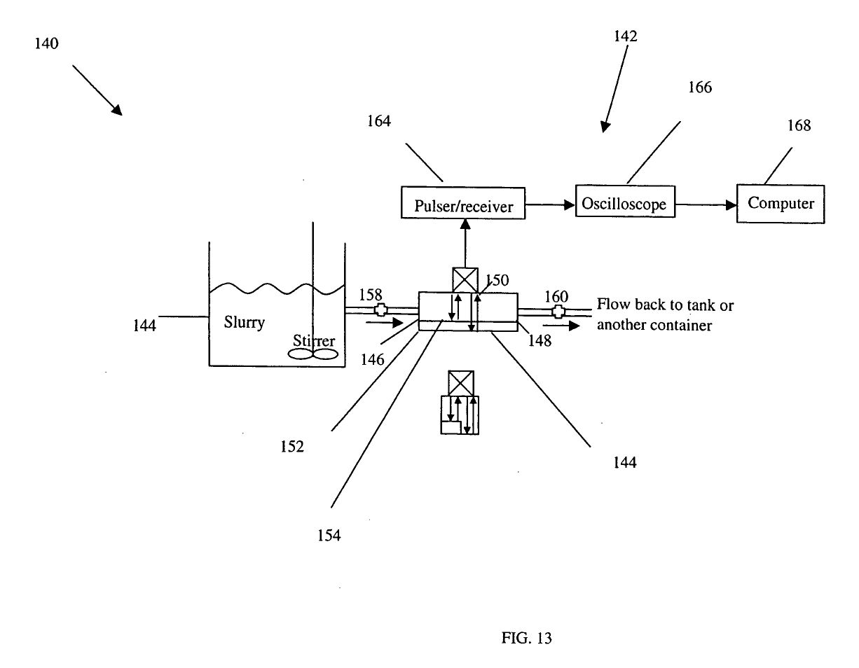

Another embodiment of the system of the invention is generally shown and referred to in FIG. 13 as system 140. System 140 generally comprises a flow-through device 142 for measuring one or more ultrasound parameters of a suspension comprising particles dispersed in a liquid carrier, generally comprising, a container 144 having an inlet 146 and an outlet 148, through which the suspension can flow; one or more ultrasonic probes 150, adapted to transmit and receive ultrasonic waves through the suspension as it flows through the container; one or more reflectors having at least two reflective surfaces 152 and 154 positioned at staggered distances from the probe surface to reflect the ultrasonic waves through the suspension onto the probe surface; and one or more fixtures or housing 156, that fix the probe and the reflector at positions with a space in between the probe surface and the reflective surface to allow the suspension to flow into the space between the probe surface and the reflective surfaces. System 140 also may comprise switches 158 and 160. System 140 allows the slurry from a suspension container to flow into the measuring system. System 140 further comprises a an ultrasound wave generator/receiver device 162 to transmit and receive the ultrasound waves to and from probe 150; and a signal processing device 164, in communication with the ultrasound wave generator to receive and process the ultrasound waves from the ultrasound wave generator/receiver device, oscilloscope 166 and processor 168 for processing and analyzing the ultrasound signals.

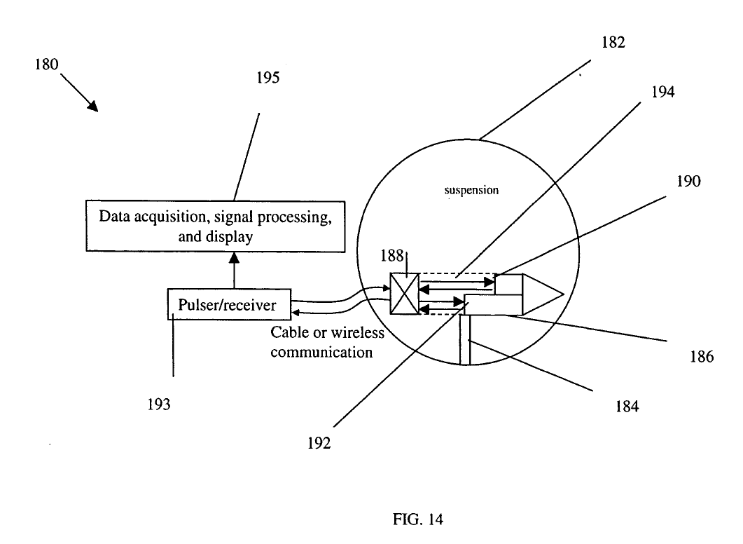

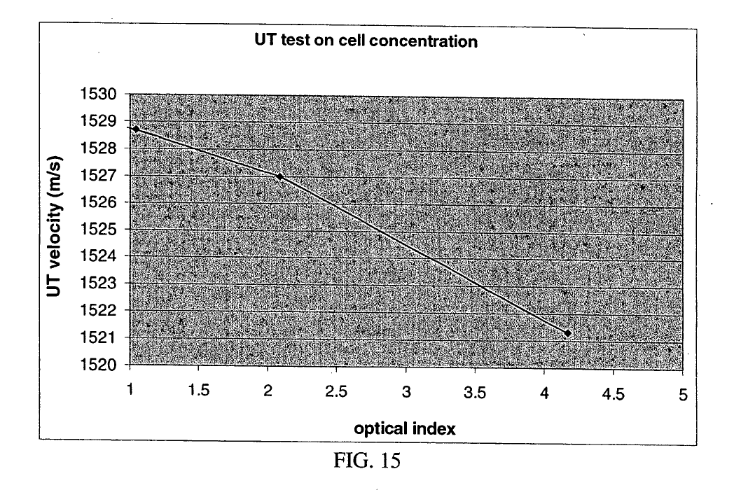

Another embodiment of the system of the invention is generally shown and referred to in FIG. 14 as system 180. System 180 comprises an ultrasound suspension measurement system that is built into a bioprocessor 182. System 180 generally comprises, an arm 184 to hold and support one or more ultrasonic device 186 within bioprocessor 182. Device 186 is not drawn to scale in FIG. 14, but rather is enlarge to illustrate the components of device 186. Device 186 comprises probe 188, to transmit and receive ultrasonic waves through the suspension in the tank (bioprocessor 182); one or more reflectors having at least two reflective surfaces 190 and 192 positioned at staggered distances from the probe surface to reflect the ultrasonic waves through the suspension onto the probe surface; and housing 194, to support and fix the probe and the reflector at positions with a space in between the probe surface and the reflective surface to allow the suspension to flow into the space between the probe surface and the reflective surfaces.

System 180 may further comprise an ultrasound wave generator/receiver device 192 to transmit and receive the ultrasound waves to and from probe 180; and a signal processing device, in communication with the ultrasound wave generator to receive and process the ultrasound waves from the ultrasound wave generator/receiver device, an oscilloscope and a processor for processing and analyzing the ultrasound signals. Device 186 may communicate with device 192 through a cable or wirelessly.

To achieve highly accurate measurements using a single-surface reflector such as the embodiments shown in FIG. 1 and FIG. 2, the distance between the probe and the reflector should either be tightly controlled structurally or be factored into the signal analysis as a contemporaneous measurement or as variable. For example, if the distance between the reflector and probe surface changed because of vibrations or slips, a distance measurement should be taken and factored in to the analysis.

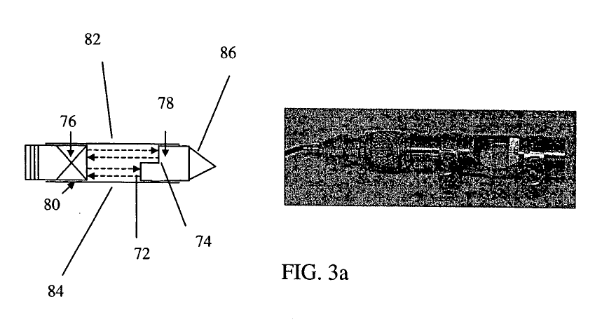

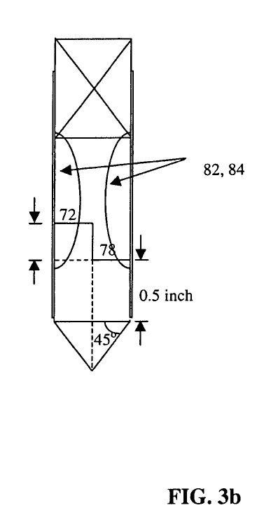

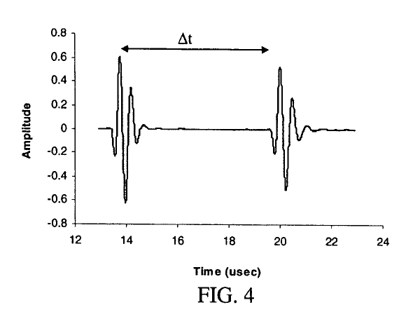

To reduce possible distance measurement errors, a two-surface reflector may be incorporated into the immersible device. An embodiment of such a device with at least two reflective surfaces is generally shown and described in FIGS. 3a and 3b as device 70. The dash lines B and C shown in FIG. 3 illustrate two possible ultrasound paths. This example embodiment obviates the need to compare two round trip echoes. Instead, two echoes from the separate reflecting surfaces 72 and 74 may be compared. The distance between the reflective surfaces of this embodiment is 0.2+/−0.0001 inch and the reflective surfaces should be parallel to each other. Even the distance between probe 76 and reflector 78 can change without negatively impacting the accuracy because the distance between the two echoes is fixed. This configuration is generally more robust against distance errors. The housing 80 may be used to further minimize any possible angle misalignment between probe 76 and reflector 78. This embodiment of the housing is a hollow tube and has an outside diameter of between about 0.622 to 0.624 inch and an inside diameter of about 0.624 inch plus the slide fit. The housing may be made from any material that is suitable for a particular application. This example embodiment of the housing is stainless steel. The openings 82 and 84 in this embodiment are about 1.0 inch in length. Reflector cone 86 in this embodiment has an internal angle of 45 degrees. In this embodiment, the distance between reflective surface 72 and the base of cone 86 is about 0.5 inch. FIG. 4 shows the typical waveform collected in slurries with the two-surface reflector design. Zero crossing processes two distinct echoes from separate reflector surfaces to obtain the time difference and then velocity.

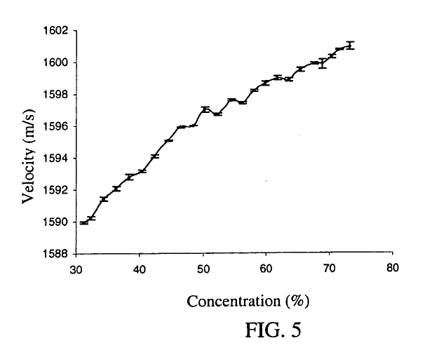

Depending on whether the device, methods and systems of the invention are use in an off-line application or are incorporated into an in-line application at a point in the system in which the suspension may need to be maintained in a more homogenized state, stirring bars may be incorporated into the system to maintain appropriate distribution of the particles in suspension to obtain accurate measurements. An example of such stirring bars is mechanical stirring bar such as Caframo Model RZR1 mechanical stirrer, which has a variable speed control and a stirring head that can be clamped in a fixed vertical position. FIG. 5 is a graph illustrating the low levels of variability when constant stirring bar is used for certain suitable applications.

Without stirring, particles in the slurry start to settle downward. Ultrasound parameters can be measured at multiple times during the particle settlement process. For example, the ultrasound velocity and/or attenuation may be measured every 30 seconds multiple times (e.g. 20 times) as the particles settle. The ultrasound parameter change versus time during particle settlement process (rate of settlement) may be used to determine other valuable information, such as, but not limited to, particle size, particle contamination status, particle aging status, and particle density.

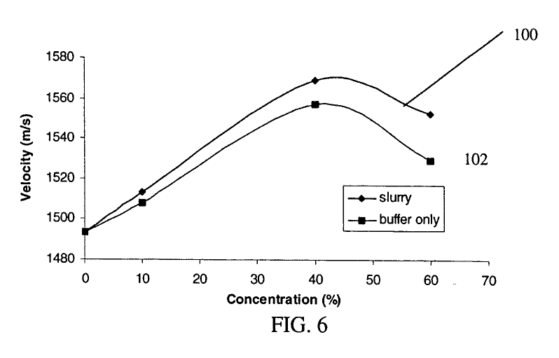

The liquid carrier, such as media or buffer, also may introduce variations into a system, as illustrated by the graph in FIG. 6. FIG. 6 shows line 100 as suspension velocity vs. suspension % for one set of QFF samples, which are all labeled with 10% ethanol buffers, and line 102 as buffer velocity vs. suspension % for the same set of QFF samples. Line 102 clearly shows buffer variations even though all the buffers are labeled as 10% ethanol. The similarity between lines 100 and 102 demonstrates that buffer variation may have a significant effect on suspension velocity measurements. To adjust for such variation, the suspension velocity is corrected based on the buffer velocity. The resin material, in this example, is modified by the buffer liquid property. To correct for these modification, the suspension velocity is the buffer velocity modified by the resin, depending on the resin %, wherein V (resin %) is the corrected velocity, as follows:

V(resin %)=V_suspension−V_buffer.

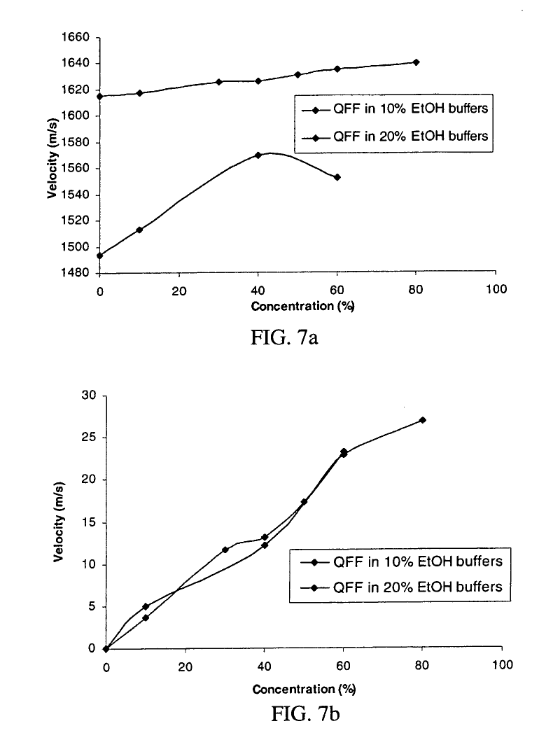

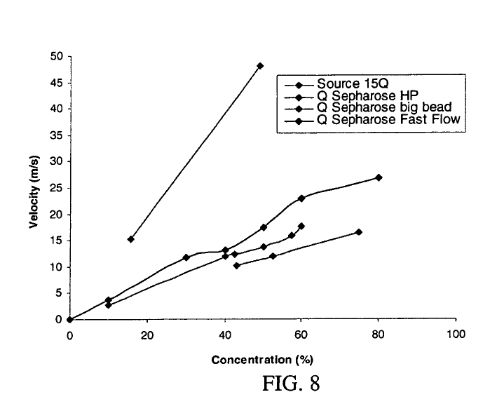

FIG. 7a shows the velocity of QFF vs. suspension concentration for two sets of samples. More specifically, FIG. 7a shows a large suspension velocity difference between two sets of QFF samples: QFF in 10% ethanol and QFF in 20% ethanol. FIG. 7b shows the corrected velocity vs. % for the two sets of QFF samples. Comparison between FIG. 7a and FIG. 7b shows that velocity variation is greatly reduced from ˜100 m/s to <3 m/s by velocity correction. FIG. 8 shows the corrected velocity vs. suspension % for four different bead materials. All the velocities have been corrected based on two independent measurements: one for suspension velocity and one for buffer only. FIG. 8 also indicates that: for suspension concentration measurements, each bead material has its own velocity vs. % curve; unique curve distribution may be used for bead identification and quality monitoring (aging, size change, etc.); and monitoring bead settlement process can be used to obtain additional information about the particles in the suspension such, but not limited to, bead density, size and aging.

Variations in the liquid carrier may be reduce using an off-line calibration method, such as the following example:
Shake 5 L suspension bottle to homogenous state;
Transfer ˜0.5 L to a new container A (for example, 2 L Nalgene bottle);
Fill with 10% EtOH up to 2 L mark;
Let it settle overnight;
Remove supernatant (˜1.5 L) without disturbing the bead bed and store the supernatant buffer solution in another container B;
Transfer suspension from container A to a measuring cylinder (1 L);
Wait overnight;
Measure heights of solid bead (x), liquid (y). So suspension concentration is x/y=z %;
Transfer suspension from the measuring cylinder back to container A. Rinse with small amount of buffer solution in container B, if needed calculate new suspension concentration;
Stir and take first velocity measurement in container A;
Add buffer solution in container B to A to make a lower % sample;
Take a velocity measurement;
Repeat Steps 11 and 12 until running out of buffer solution in container B.

Although this sample preparation method will ensure that the same buffer % for all the suspension samples is used, in-line applications typically require an in-line calibration method. Therefore, to reduce buffer variation in an in-line system, one or more of the embodiments of the methods and systems may incorporate dual or multiple immersible devices. Two ultrasound devices or probes are used in combination: one to measure suspension velocity and the other to measure buffer only velocity with a filter around the probe to block bead entrance and only allow buffer solution to go through the filter. Dependent on the filter pore size, time varies for buffer to enter and fully occupy the ultrasound path. As a non-limiting example, several seconds may be sufficient time for a Q Sepharose big bead suspension sample using a 12 μm filter. Any air bubbles in the ultrasound path are preferably removed by a variety of methods, such as, but not limited to, slight agitation of the device or liquid in the flow space.

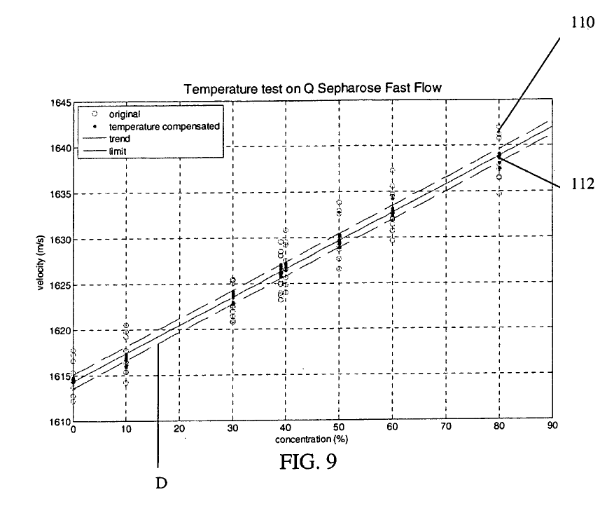

Temperature also may play a significant part in determining one or more of the ultrasound parameters of the suspension. For example, temperature variations may significantly affect velocity measurements as shown in FIG. 9. FIG. 9 displays QFF velocities at different suspension temperatures within the range [9° C., 30° C.] at each suspension concentration. Circles 110 are the measured velocities and dots 112 are the compensated velocities after temperature regression. Dash lines D are velocity bounds for +/−2% concentration change.

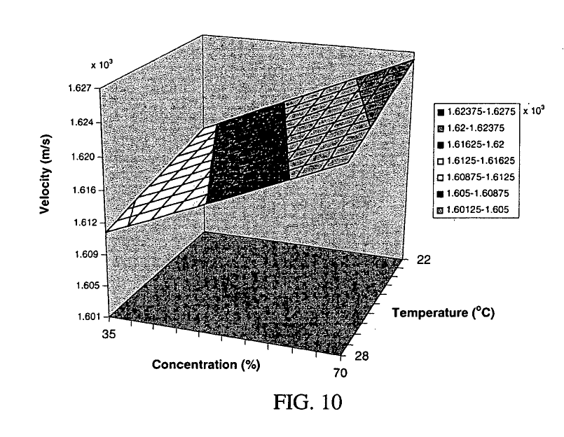

A 3D regression plot of velocity vs. concentration and temperature is shown in FIG. 10. Temperature and concentration influences are independent in this case. The trend in the 3D regression plot is summarized in a regression equation as below.

Velocity (m/s)=1624.753672+0.307557*concentration−0.581831*temperature

The regression equations are different for different slurries depending on bead and buffer combinations. To accurately compensate for the temperature variation, temperature in suspension should to be measured precisely, preferably within +/−0.05° C. accuracy. Although it may be desired to control the temperature of the chamber to keep suspension temperature constant during ultrasound measurements, this configuration may not be suited to an industrial manufacturing environment. For applications, where it is not suitable or desired to control the temperature of the suspension, temperature recording and compensation may be used to reduce temperature variation in suspension measurements. From these temperature measurements, a temperature compensation curve is generated that can be applied to the velocity measurements. Temperature compensation curves may be generated using measurements from multiple temperature points.

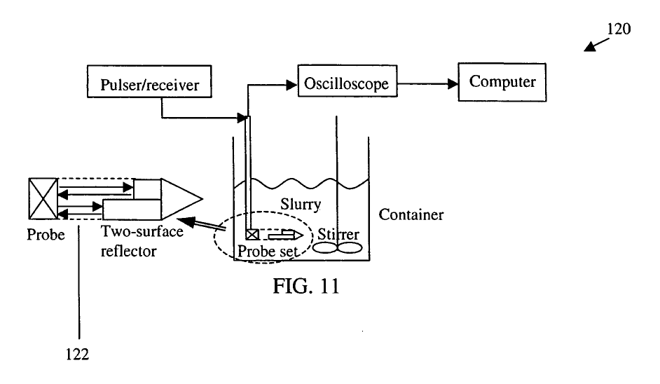

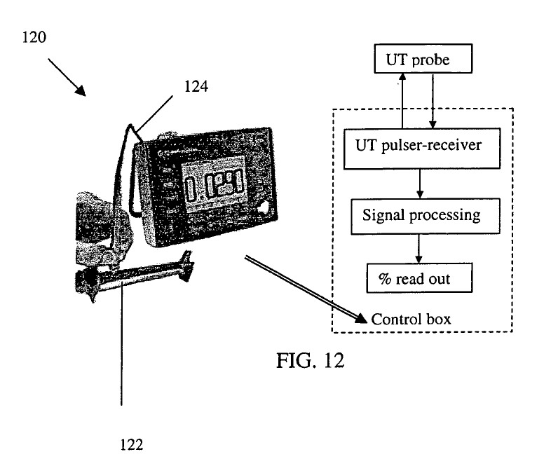

The immersible devices and the methods and systems may be adapted for use in bench top and portable devices such as, for example, field devices. For example, FIG. 11 is a schematic diagram of a situation in which a portable device may be used. This embodiment houses the pulser/receiver, the oscilloscope and the processor/computer in one unit 120, as shown in FIG. 12. The immersible device 122 communicates with unit 120 via cable 124. Unit 10 may also comprise communication ports to allow uploads and downloads of information, such as, but not limited to, software and data, from and to, digital devices such as, but not limited to, laptops, personal computers, and handheld devices, for further transmission, data processing, and plotting. Unit 10 may communicate with such devices by hardline or wirelessly.

FIG. 13 is a graph illustrating the results using an embodiment of the system for measuring one or more ultrasound parameters of a suspension comprising particulate biomaterial dispersed in a liquid carrier. This example measured the ultrasound velocity of a cell culture that was used to determine the concentration or density of the cells in the culture. The graph also shows the optical index of the cell culture relative to cell concentration. The measurements were taken with an immersible device comprising a 2.25 Mhz Panametrics probe with a reflector having two staggered reflective surfaces. A Panametrics ultrasound generator/receiver, Model 5072PR, was used to generate and receive the ultrasound signals.

For this example, BL21 [DE3] were grown in a broth comprising 12 g bacto-tryptone, 24 g bacto-yeast extract, 4 mL glycerol, 2.31 g KH₂PO₄ monobasic, and 12.54 g K₂HPO₄ dibasic/L. The cells were allowed to incubate overnight (˜16 hrs) at room temperature (˜22 C) and then serially diluted to obtain concentration point measurements.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for measuring one or more ultrasound parameters of a suspension comprising particulate biomaterial dispersed in a liquid carrier comprising,
a bioprocessor for processing the particulate biomaterial;
one or more ultrasound devices, comprising,
one or more ultrasound probes, adapted to transmit and receive ultrasound waves, and having a surface;
one or more reflectors having at least one reflective surface positioned to reflect the ultrasound waves onto the probe surface;
a housing, that fixes the probe and the reflector at positions with a space in between the probe surface and the reflective surface, comprising an opening into the housing that is of a size sufficient to allow the suspension to flow into the space between the probe surface and the reflective surface;
an ultrasound wave generator/receiver device, in communication with the immersible device to transmit and receive the ultrasound waves to and from the immersible device; and
a signal processing device, in communication with the ultrasound wave generator to receive and process the ultrasound waves from the ultrasound wave generator/receiver device.

2. The system of claim 1, wherein the reflector has at least two reflective surfaces positioned at staggered distances from the probe surface.

3. The system of claim 1, comprising two or more devices, at least one of which is adapted to calibrate the liquid carrier by further comprising a filter adapted to prevent the particles from flowing into the space while allowing the liquid carrier to flow into the space of the calibrating device.

4. The system of claim 1, wherein the bioreactor comprises one or more ports for accessing the suspension, and wherein at least one of the devices is adapted to be immersed in the suspension via one of the ports.

5. The system of claim 1, wherein the particulate biomaterial comprises one or more of a plurality of cells or subcellular material.

6. The system of claim 5, wherein the liquid carrier comprises one or more of a media, a buffer or a cell nutrient.

7. The system of claim 1, further comprising a suspension processing unit, for processing the suspension, comprising one or more fixtures for supporting one or more of the devices inside the processing unit so that the suspension can flow into the space between the probe surface and the reflective surface.

8. The system of claim 1, wherein at least one of the ultrasound parameters of the suspension is used to determine a rate of settlement.

9. The system of claim 8, further comprising, determining a substantially contemporaneous temperature of the suspension, and wherein an ultrasound velocity is determined in part by the temperature of the suspension.

10. The system of claim 9, wherein the processing step further comprises determining a concentration measurement of the particles in the suspension based at least in part on the ultrasound velocity.

11. A method for measuring one or more ultrasound parameters of a suspension comprising a plurality of particulate biomaterials dispersed in a liquid carrier, comprising the steps of,
a) introducing into the suspension of particulate biomaterials, an ultrasound device, comprising,
one or more ultrasonic probes, adapted to transmit and receive ultrasound waves, and having a surface;
one or more reflectors having at least one reflective surface positioned to reflect the ultrasound waves onto the probe surface;
a housing, that fixes the probe and the reflector at positions with a space in between the probe surface and the reflective surface, comprising an opening into the housing that is of a size sufficient to allow the suspension to flow into the space between the probe surface and the reflective surface;
b) initiating transmission of the ultrasound waves from the probe through the suspension flowing into the space between the probe surface and the reflective surface;
c) processing the ultrasound waves reflected onto the probe surface, to determine one or more of the ultrasound parameters of the suspension.

12. The method of claim 11, further comprising providing a bioreactor for processing the particulate biomaterials.

13. The method of claim 12, wherein the bioreactor comprises one or more ports for accessing the suspension, and wherein at least one of the devices is adapted to be introduced into the suspension via one or more of the ports.

14. The method of claim 11 wherein the introducing step comprises introducing into the suspension two or more devices, at least one of which is adapted to calibrate the liquid carrier by further comprising a filter adapted to prevent the particles from flowing into the space while allowing the liquid carrier to flow into the space of the calibrating device.

15. The method of claim 11, wherein the particulate biomaterial comprises one or more of a plurality of cells or subcellular material.

16. The method of claim 15, wherein the liquid carrier comprises one or more of a media, a buffer or a cell nutrient.

17. The method of claim 15 wherein at least one of the ultrasound parameters of the suspension determined in the processing step is ultrasound velocity.

18. The method of claim 11, wherein the reflector has at least two reflective surfaces positioned at staggered distances from the probe surface.

19. The method of claim 17, further comprising, determining a substantially contemporaneous temperature of the suspension, and wherein the ultrasound velocity is determined in part by the temperature of the suspension.

20. The method of claim 19, wherein the processing step further comprises determining a concentration measurement of the particles in the suspension based at least in part on the ultrasound velocity.

21. The method of claim 20, wherein the introducing step comprises introducing into the suspension two or more devices, at least one of which is adapted to calibrate the liquid carrier by further comprising a filter adapted to prevent the particles from flowing into the space while allowing the liquid carrier to flow into the space of the calibrating device.

22. The method of claim 11, wherein at least one of the ultrasound parameters is velocity and the processing step comprising determining a concentraton of the particulate biomaterials in the liquid carrier.

23. The method of claim 22, wherein the particulate biomaterials comprise cells and wherein the concentration determined is the density of cells in the liquid carrier.

24. A flow-through device for measuring one or more ultrasound parameters of a suspension comprising a plurality of particulate biomaterials dispersed in a liquid carrier, comprising,
a container having an inlet and an outlet, through which the suspension can flow;
one or more ultrasonic probes, adapted to transmit and receive ultrasonic waves through the suspension as it flows through the container, and having a surface;
one or more reflectors having at least two reflective surfaces positioned at staggered distances from the probe surface to reflect the ultrasonic waves through the suspension onto the probe surface; and
wherein the probe and the reflector are fixed at positions in the container with a space in between the probe surface and the reflective surface to allow the suspension to flow into the space between the probe surface and the reflective surfaces.
